(19) United States
(12) Patent Application Publication
(10) Pub. No.: US 2007/0264455 A1
(43) Pub. Date: Nov. 15, 2007

(54) Nano far infrared paster

(76) Inventors: Chun Yu Chin, Taipei Hsien (TW); Shyan-Wei Chen, Taipei Hsien (TW)

Correspondence Address: TROXELL LAW OFFICE PLLC, SUITE 1404, 5205 LEESBURG PIKE, FALLS CHURCH, VA, 22041, US

(21) Appl. No.: 11/430,925

(22) Filed: May 10, 2006

(51) Int. Cl. B32B 33/00

(52) U.S. Cl. 428/40.1

(57) ABSTRACT

A nano far infrared paster convenient for adhering to the back of the user's neck or waist to treat the central nervous system with far infrared rays is disclosed to include a nano far infrared base layer and a strippable covering on one side of the nano far infrared base layer, which nano far infrared base layer having a cloth layer and an adhesive layer formed of nano far infrared powder and liquid silicon pressure sensitive adhesive and bonded to one side of the cloth layer.

### BACKGROUND OF THE INVENTION

1. Field of the Invention

The present invention relates to a paster and more particularly, to a nano far infrared paster that stimulates the central nervous system, achieving many health benefits.

2. Description of the Related Art

80% of the energy of the sun is infrared rays. 80% of infrared rays is of wavelength within 10˜20 microns. Over 60% of the energy of the sun is infrared rays of wavelength within 10˜20 microns, which is helpful to the health of human beings. Infrared rays include near infrared rays of wavelength within 0.75˜4 microns and far infrared rays of wavelength within 4˜1000 microns. Far infrared rays of wavelength within 8˜14 microns are most helpful to human health because of their properties of radiation, deep penetration, and resonance absorption. The physical characteristics of far infrared rays are invisible, linearity, refractivity. Far infrared rays can be absorbed and produce warmth and harmonize with the natural life-force released by the human body to enhance resonance absorption. Application of nano far infrared rays in medical treatment is safe without risk of tissue destruction. Many researchers have found that far infrared rays help to promote health profoundly. Far infrared radiation is popular in many countries. Recently, numerous research papers on clinical experimentation and application of far infrared rays are published. Far infrared rays can reach well into subcutaneous layers of the body (or water) with its deep penetration ability, generating internal warmth suitable for molecule activation in living tissue. When the body of a human being is radiated with far infrared rays, there is intrinsic vibration of body components—water, protein, fat, enzymes. At this time, the interior of molecules—atoms and atomic structures—experience the resonance absorption of far infrared rays of their same frequency. In summary, far infrared rays help to provide people with the most healing and beneficial water available and will help to enhance and energize people's physical and spiritual states. It is also a fact that materials like clothing can keep our body warm and sweat, but it does not emit far infrared rays for absorption—only materials that contain far infrared materials have the therapeutic properties if worn. When used on a long term basis our body will achieve optimum health benefits.

### SUMMARY OF THE INVENTION

The present invention has been accomplished under the circumstances in view. It is one objective of the present invention to provide a nano far infrared paster that can be conveniently adhered to the back of the user's neck or waist corresponding to the central nervous system for enabling the user's body to receive radiation of far infrared rays gradually without causing any inconvenience in the user's daily life. It is another objective of the present invention to provide a nano far infrared paster that emits far infrared rays into deep regions of the user's body to increase the temperature of the radiated area and to expand the user's blood vessels, thereby stimulating blood circulation, promoting metabolism, enhancing tissue reproduction and anticonvulsant power of the user's body, constraining abnormal excitement of the user's sensory nerves, and modulating autonomic plexus. It is still another objective of the present invention to provide a nano far infrared paster that is safe in use without causing any medical allergy or side effects.

### BRIEF DESCRIPTION OF THE DRAWING

FIG. 1 is a schematic plain view of a nano far infrared paster in accordance with the present invention.

FIG. 2 is a schematic drawing showing an application example of the present invention.

FIG. 3 is a schematic plain view of an alternate form of the nano far infrared paster in accordance with the present invention.

### DETAILED DESCRIPTION OF THE INVENTION

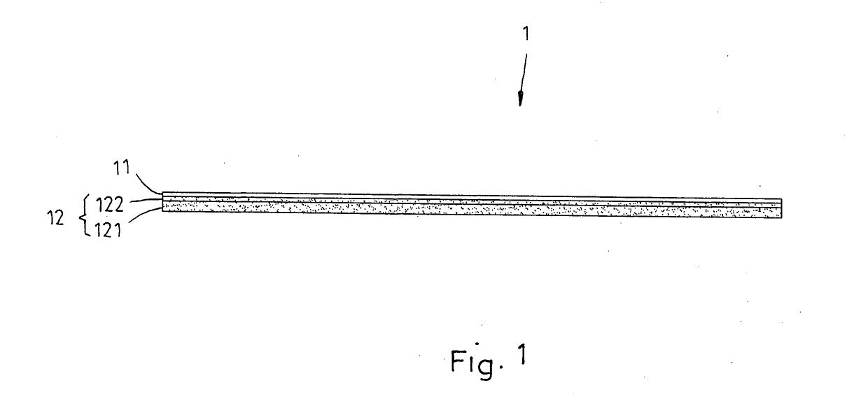

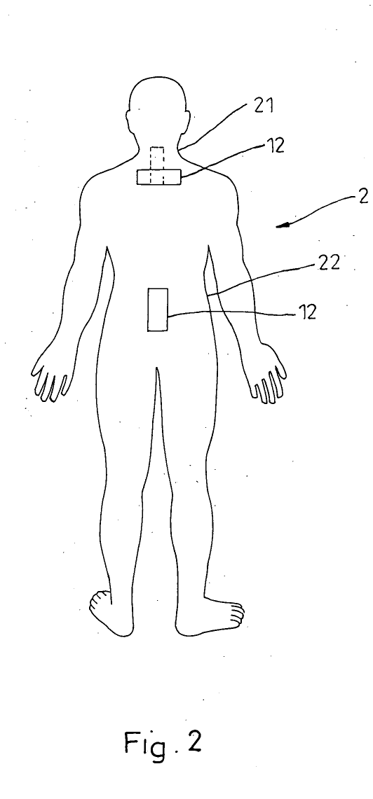

Referring to FIGS. 1 and 2, a nano far infrared paster 1 in accordance with the present invention is shown comprising a covering 11 and a nano far infrared base layer 12. The covering 11 is a plastic film or strippable paper covered on the nano infrared base layer 12. The nano far infrared base layer 12 comprises a cloth layer 121, and an adhesive layer 122 bonded to one side of the cloth layer 121. The cloth layer 121 is preferably prepared from spandex. The adhesive layer 122 is formed of a mixture of nano far infrared powder and liquid silicon pressure sensitive adhesive. Alternatively, the adhesive layer 122 can be formed of a mixture of nano far infrared powder and liquid state acrylic resin. The liquid state mixture is applied to the prepared cotton cloth and then heated to solid state.

Referring to FIG. 2 and FIG. 1 again, after removal of the covering 11 from the nano far infrared base layer 12, the nano far infrared base layer 12 is adhered to the back of the neck 21 or waist 22 of the user's body 2, enabling the body 2 to receive the radiation of nano far infrared rays from the nano far infrared powder of the adhesive layer 122 of the nano far infrared base layer 12 to stimulate the central nervous system, achieving various expected health benefits without causing inconvenience in the user's daily life.

In one fabrication example of the present invention, the fabrication of the nano far infrared base layer 12 includes the steps of: (a) mixing 20 wt % nano far infrared powder with 80 wt % liquid silicon pressure sensitive adhesive (or liquid state acrylic resin) to form a mixture; (b) pouring the mixture thus obtained in the cavity of a die cast mold made subject to a predetermined shape and thickness, and then covering the mixture with a piece of spandex cloth; (c) heating the die case mold to about 120° C.˜130° C. under a predetermined pressure for a predetermined length of time to harden the mixture and to have the piece of spandex cloth (the cloth layer 121) be bonded to the hardened mixture (the adhesive layer 122). After removal of the finished nano far infrared base layer 12 from the die cast mold, the prepared covering 11 is adhered to the adhesive layer 122 of the nano far infrared base layer 12, and therefore the desired nano far infrared paster 1 is thus obtained.

Further, in case liquid state acrylic resin is used, it is diluted with a small amount of toluene or ethyl acetate before mixing with nano far infrared powder.

Further, the aforesaid nano far infrared powder is a compound of zinc powder, aluminum powder, titanium powder and antimony powder.

Further, instead of 20 wt % nano far infrared powder and 80 wt % liquid silicon pressure sensitive adhesive (or liquid state acrylic resin), the adhesive layer 122 of the nano far infrared base layer 12 may contain 14 wt % nano far infrared powder, 1 wt % photocatalyst, and 5 wt % negative ion powder. Alternatively, the adhesive layer 122 of the nano far infrared base layer 12 can be made comprising 18 wt % nano far infrared powder and 2 wt % photocatalyst, or comprising 15 wt % nano far infrared powder and 5 wt % negative ion powder.

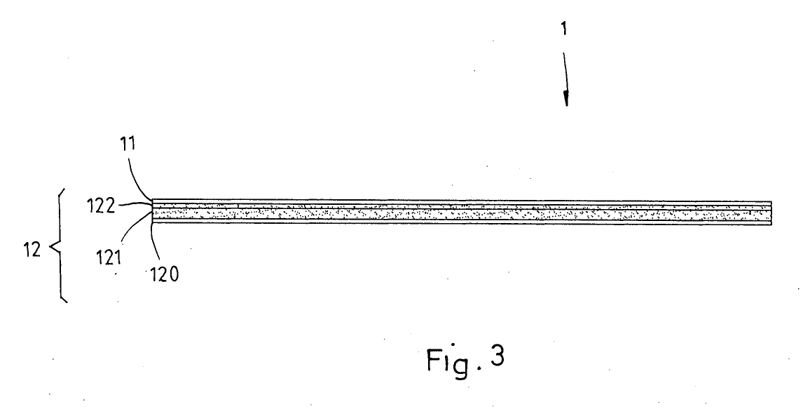

Referring to FIG. 3, a plastic film 120 may be adhered to the bottom side of the cloth layer 121 opposite to the adhesive layer 122.

As indicated above, the invention provides a nano far infrared paster, which has the following advantages:

1. By means of the nano far infrared base layer 12, the nano far infrared paster can be adhered to the back of the user's neck or waist for enabling the user's central nervous system to be gradually radiated by far infrared rays, and therefore the desired health benefits are achieved.

2. The invention has nano far infrared powder be contained in the paster and kept in close contact with the user's body so that far infrared rays penetrates the skin of the user's body to a deep are under the skin of the user's body without leaving a trace. The radiation of the far infrared rays increases the temperature of the radiated area deep in the user's body and expands the blood vessels, thereby stimulating blood circulation, promoting metabolism, enhancing tissue reproduction and anticonvulsant power of the body, constraining abnormal excitement of the sensory nerves, and modulating autonomic plexus.

3. When in use, the covering 11 is removed from the nano far infrared base layer 12, and then the nano far infrared base layer 12 is directly adhered to the user's body without causing medical allergy.

As indicated above, the nano far infrared paster of the present invention provides the follow health benefits:
1. Relief stress: The radiation of far infrared rays helps discharge of waste matters accumulated in the body, thereby giving the user relief from fatigue and stress.
2. Improvement on shoulder stiffness and pain of waist: The radiation of far infrared rays promotes blood circulation, thereby improving shoulder stiffness and pain of waist.
3. Improvement on athletic injury and function of joints: Excessive exercise breaks body equilibrium, thereby resulting in many diseases. The radiation of far infrared rays helps discharge of lactic acid and waste matters from the body, thereby promoting metabolism and improving blood circulation.
4. Improvement on blood circulation and high/low blood pressure: Blood is the fluid of life, transporting oxygen from the lungs to body tissue and carbon dioxide from body tissue to the lungs. Blood is the fluid of growth, transporting nourishment from digestion and hormones from glands throughout the body. Disorder of blood circulation causes many health problems. The radiation of nano far infrared rays promotes blood circulation and prevents blood vessel diseases, achieving many health benefits.
5. Promotion of metabolism and elimination of excessive fat: The radiation of nano far infrared rays lowers the concentration of cholesterol and triglyceride in blood, has anti-aging and beauty and fat loosing benefits, and shows improvement on arteriolosclerosis.
6. Discharge of harmful heavy metals: There are 55 mineral substances in the human body that modulate physical functioning of the body. However, excessive amount of harmful mineral substances or insufficient amount of requisite mineral substances in the body will cause diseases. The radiation of nano far infrared rays helps discharge harmful mineral substances from the body, keeping the body healthy.

What is claimed is:

1. A nano far infrared paster comprising a nano far infrared base layer and a strippable covering on one side of said nano far infrared base layer, said nano far infrared base layer comprising a cloth layer and an adhesive layer bonded to one side of said cloth layer, said adhesive layer containing a nano far infrared powder.

2. The nano far infrared paster as claimed in claim 1, wherein said adhesive layer is formed of nano far infrared powder and liquid silicon pressure sensitive adhesive.

3. The nano far infrared paster as claimed in claim 1, wherein said covering is a strippable paper.

4. A nano far infrared paster comprising:
a nano far infrared base layer, said nano far infrared base layer comprising a cloth layer and an adhesive layer formed of a nano far infrared powder and liquid state acrylic resin and bonded to one side of said cloth layer;
a covering formed of a plastic film that is strippable on one side of said nano far infrared base layer, and a plastic film bonded to one side of; and
a plastic film bonded to one side of said cloth layer opposite to said adhesive layer.

5. A nano far infrared paster comprising:
a nano far infrared base layer, said nano far infrared base layer comprising a cloth layer and an adhesive layer bonded to one side of said cloth layer, said adhesive layer being formed of a nano far infrared powder, negative ion powder, photocatalyst powder, and liquid silicon pressure sensitive adhesive; and
a covering formed of a plastic film and that is strippable on one side of said nano far infrared base layer.

6. A nano far infrared paster comprising:
a nano far infrared base layer, said nano far infrared base layer comprising a cloth layer and an adhesive layer bonded to one side of said cloth layer, said adhesive layer being formed of a nano far infrared powder, negative ion powder, and liquid silicon pressure sensitive adhesive; and
a covering formed of a plastic film that is strippable on one side of said nano far infrared base layer.

7. A nano far infrared paster comprising:
a nano far infrared base layer, said nano far infrared base layer comprising a cloth layer and an adhesive layer bonded to one side of said cloth layer, said adhesive layer being formed of a nano far infrared powder, photocatalyst powder, and liquid silicon pressure sensitive adhesive; and
a covering formed of a plastic film that is strippable on one side of said nano far infrared base layer.
